(19) United States
(12) Patent Application Publication
(10) Pub. No.: US 2013/0208937 A1
(43) Pub. Date: Aug. 15, 2013

(54) PERSONAL AUDIO DEVICE INCLUDING A CASE

(71) Applicants: Douglas Evan Stern, Providence, RI (US); David Scott Medeiros, Barrington, RI (US); Michael Donald Troiano, JR., Pawtucket, RI (US)

(72) Inventors: Douglas Evan Stern, Providence, RI (US); David Scott Medeiros, Barrington, RI (US); Michael Donald Troiano, JR., Pawtucket, RI (US)

(21) Appl. No.: 13/684,493

(22) Filed: Nov. 23, 2012

Related U.S. Application Data
(60) Provisional application No. 61/563,043, filed on Nov. 23, 2011.

(51) Int. Cl. H04R 1/10

(52) U.S. Cl. CPC H04R 1/1033
USPC 381/332

(57) ABSTRACT

A case that supports integrated personal audio speakers for easy and secure access for connection to an electronic device is provided. The case includes an extension and retraction mechanism to allow for extension of the personal audio speakers from within the case, and retraction of the same into the case in a manner that avoids tangling of the cord of the personal audio speakers. In one embodiment, the case is configured to store and protect the electronic device as well, and includes an extendable and retractable popper mechanism to electronically connect an audio plug supported by the case with an audio jack of the electronic device. The popper mechanism moves the plug between a retracted position supported within the case and out of engagement with the electronic device, an extended position where the plug extends from within the case, and an engaged position where the plug is operatively engaged with the jack of the electronic device.

### CROSS-REFERENCE TO RELATED APPLICATIONS

This application claims the benefit of priority to U.S. Provisional Patent Application No. 61/563,043, filed Nov. 23, 2011 and entitled “Retractable Audio Device”, the entire contents of the application being incorporated herein by reference in its entirety.

### TECHNICAL FIELD

The present invention relates to an audio device stored in a case, and more particularly, to retractable personal speakers including a case for removably securing and electronically coupling to an electronics device having audio output.

### BACKGROUND

Private or personal audio speakers, commonly known as headphones, stereo phones, headsets, earphones, ear buds, or colloquially as cans, are traditionally utilized with computing, audio and/or telecommunications devices by electronically coupling the speakers to the device, for example through a jack, so that the user can listen to audio output from the device without others in the vicinity readily hearing the output. These devices may also have the addition of a microphone used for traditional two-way communication.

By their nature, conventional personal audio speakers are separate components that are plugged into and electrically coupled to an audio device during use. Because the personal audio speakers are removably connected to the audio device, once unplugged and removed from the audio device, they may be placed in an area not convenient or in close proximity of the device and may be forgotten, lost, or damaged. In these instances, the user may depend on the internal speaker connected to the device for audio output, or have no audio output.

In addition to being easily displaced, forgotten or damaged, even when utilized with the electronic device personal audio speakers are not very convenient. For example, the personal audio speakers require a minimum length of wire attached to the speakers to fit comfortably in or on a user's ears during operation. This length of wire often becomes tangled and knotted when stored or during operation.

### SUMMARY

The inconvenience of prior art personal audio speakers has been found to take many forms. For example, the cord in traditional personal audio speakers comes in a predetermined length, which must be long enough to fit the user. Therefore users cannot adjust this length to fit their particular needs during use. Excess length can be an impediment as it may become tangled, knotted or interfere with other objects. This extra length can also become a serious impediment and possible danger when the user is engaged in physical activity. The predetermined length of cord can also make the personal audio speakers difficult to organize and store.

Often users will wind the cord from the personal audio speakers into various configurations, for example around their fingers, then wrap a portion of length around the center creating a figure 8 bundle. Manually winding the cord upon itself requires manual dexterity and is not a reliable form of storage, often resulting in entanglements and damage to the wire connections in the device. The personal audio speakers can come unwound in storage or during retrieval and can easily become tangled. In addition, personal audio speakers, particularly the ear bud type, generally include a rubber, silicone or foam ear part that fits in the ear canal. These parts are friction fit and can come loose if not stored in a container. If the ear cover is lost the personal audio speakers may become obsolete or at the least, become less effective.

Personal audio speakers are stored in a decoupled mode from the electronic devices they are utilized with and must be coupled to the devices during operation. In order to couple the personal audio speakers with the electronic device the user must align the male audio plug with the opening of the female audio jack built into the electronic device. Manual dexterity is required to align the male audio plug and the female audio jack. This operation can be hard to achieve using one hand and is difficult to execute if the operator is not looking at the device, is executing this operation in low light or if the user is disabled or otherwise challenged.

The invention disclosed herein provides a case to support integrated personal audio speakers, the personal audio speakers being easily accessed and stored by the majority of users. The case may further be configured to support and protect an electronic device, and may include an extension and retraction mechanism to allow for incremental adjustment of the personal audio speakers and retraction of the same into the case. In one embodiment, a reel that stores the length of cord of the personal audio speakers within the case without tangling is provided, the reel also allowing the length of cord to be incrementally and selectively adjusted exterior to the case during use, depending upon the needs of the user.

Because the case includes the personal audio speakers supported therein, it provides an easy and secure method of storage that keeps the personal audio speakers in close proximity to the electronic device for easy retrieval and use. To electrically couple the personal audio speakers to the electronic device, the case further includes a male audio plug, which is selectively electronically coupled to the personal audio speakers. The male audio plug is supported on a retractable and extendable stem that rides in a channel within the case for simplicity of alignment with a corresponding female audio jack on the electronic device. The plug is actuated by applying pressure to the stem, for example by depressing a button, which releases the stem and biases it into an extended position to allow the electronic device to be inserted within the case, in alignment with the audio jack of the device. The user can then exert pressure on the stem to lower and insert the male plug into engagement with the female audio jack without having to manually align the two. This connects the personal audio speakers, which are electronically connected to the audio jack, to the electronic device in a reliable manner that can be executed with a single hand.

### BRIEF DESCRIPTION OF THE DRAWINGS

The foregoing and other features and advantages will be apparent from the following description of at least one exemplary embodiment, as illustrated in the accompanying drawings in which like reference characters refer to the same or similar components throughout the different views. For purposes of clarity, not every component may be labeled in every figure. The figures are included to provide an illustration and a further understanding of the various aspects and embodiments, and are incorporated in and constitute part of the specification, but are not intended as a definition of the limits of any particular embodiment. The drawings are not necessarily to scale, emphasis instead being placed upon illustrating the principles disclosed herein.

FIG. 1 is a rear perspective view of a first embodiment of a personal audio device including a case;

FIG. 2 is a front perspective view of the case of FIG. 1;

FIG. 3 is a partially exploded rear view of the case of FIG. 1;

FIG. 4a is a partially exploded front view of the case of FIG. 1 excluding popper mechanism;

FIG. 4b is an enlarged, exploded front view of an extension and retraction mechanism of the case of FIG. 1;

FIG. 4c is an enlarged, exploded rear view of an extension and retraction mechanism of the case of FIG. 1;

FIG. 5 is a cross-sectional view of the case of FIG. 1, taken along lines 5-5 of FIG. 2;

FIG. 6a is an enlarged, interior view of one embodiment of an earpiece and biasing member of FIG. 1 in a first, secured position;

FIG. 6b is an enlarged, interior view of the earpiece and biasing member of FIG. 6a in a second, un-secured position;

FIG. 6c is an enlarged, interior view of another embodiment of an earpiece and biasing member of FIG. 1 in a first, secured position;

FIG. 6d is an enlarged, interior view of the earpiece and biasing member of FIG. 6d in a second, un-secured position;

FIGS. 7a-7c are side views of the case of FIG. 1 illustrating ejection of the personal audio device;

FIGS. 7d-7f are rear perspective views of the case of FIG. 1 illustrating ejection of the personal audio device;

FIG. 8a is an enlarged, perspective view of the storage compartment of the case of FIG. 1;

FIG. 8b is an enlarged, perspective view of the storage compartment of the case of FIG. 1 with the release bar removed;

FIG. 9a is a partially exploded front view of the case of FIG. 1 including the popper mechanism but not including the personal audio device;

FIGS. 9b-9d are enlarged interior views of the operation of the popper mechanism of the case of FIG. 1;

FIGS. 9e-9h are perspective views of the operation of the popper mechanism of the case of FIG. 1;

FIG. 10a is an interior, perspective view of the popper mechanism of FIG. 1 in a compressed position;

FIG. 10b is an interior, perspective view of the popper mechanism of FIG. 1 in an extended position;

FIG. 11a is a front, perspective view with enlarged detail of interior mute button assembly of the case of FIG. 1;

FIG. 11b is a front, perspective view with enlarged detail of exterior mute button assembly of the case of FIG. 1;

FIG. 11c is a schematic view of the operation of the mute button assembly of the case of FIG. 1 in a non-mute position;

FIG. 11d is a schematic view of the operation of the mute button assembly of the case of FIG. 1 in a mute position;

FIG. 12 is a rear perspective view of the case of FIG. 1 configured for use with an IPhone 5®;

FIGS. 13a-13b are front perspective views of the case of FIG. 1 configured for use with an IPod® Nano®;

FIG. 13c is a rear perspective view of the case of FIG. 1 configured for use with an IPod® Nano®;

FIGS. 14a-14b are rear perspective views of the case of FIG. 1 configured for use with a gaming device;

FIG. 14c is a front perspective view of the case of FIG. 1 configured for use with a gaming device;

FIG. 15a a is a rear perspective view of the case of FIG. 1 configured for use with an IPad®;

FIG. 15b a is a front perspective view of the case of FIG. 1 configured for use with an IPad®;

FIG. 15c a is a front perspective view of the case of FIG. 15b including a stand;

FIGS. 16a-16b are rear, perspective views of the case of FIG. 1 including a clip and stand in rotated and un-rotated positions;

FIGS. 16c-16e are side views showing movement of the clip and stand of FIGS. 16a-16b;

FIGS. 17a-17c are side, perspective views of the case of FIG. 1 including a stand;

FIG. 18a is a rear perspective view of a second embodiment of a case for use with a personal audio device;

FIG. 18b is front and rear perspective view of the case of FIG. 18a including exemplary electronic device for attachment thereto; and

FIG. 19 is a rear perspective view of a third embodiment of a case for use with a personal audio device where the extension and retraction mechanism is mounted to the outside of the case.

### DETAILED DESCRIPTION OF THE ILLUSTRATIVE EMBODIMENTS

The embodiments disclosed herein are directed to a case that stores an integrated personal audio device, the case also supporting and connecting to an electronic device with an audio output to secure and electrically couple the electronic device to the personal audio device. As used herein, the term “electronic device” refers to any and all electronic devices that have an audio output, such as computing, audio and/or telecommunications devices, including but not limited to mobile phones, smart phones, tablets, laptops, computers, music players, MP3 players, gaming devices and the like. As also used herein, the terms “personal audio speakers” and/or “personal audio device” are used interchangeably and refer to any device that is electronically coupled to the electronic device, such as by a jack, and which is utilized in close proximity to the user's ears so that the user can listen to audio output from the device without others in the vicinity readily hearing the audio output. Such devices include, but are not limited to, headphones, stereo phones, headsets, earphones, or ear buds and may have a single ear piece or two or more ear pieces, and which may have either a mono or stereo audio output. These devices may also have the addition of a microphone used for traditional two-way communication or other added features.

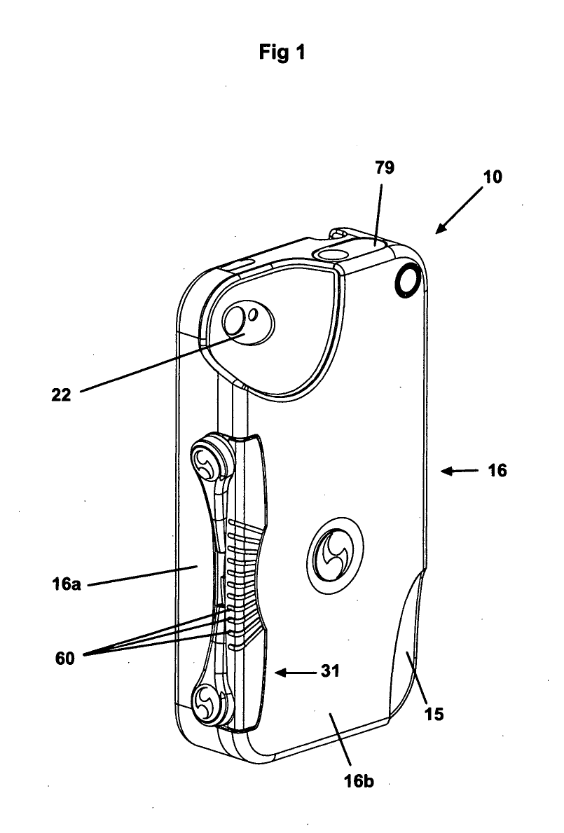

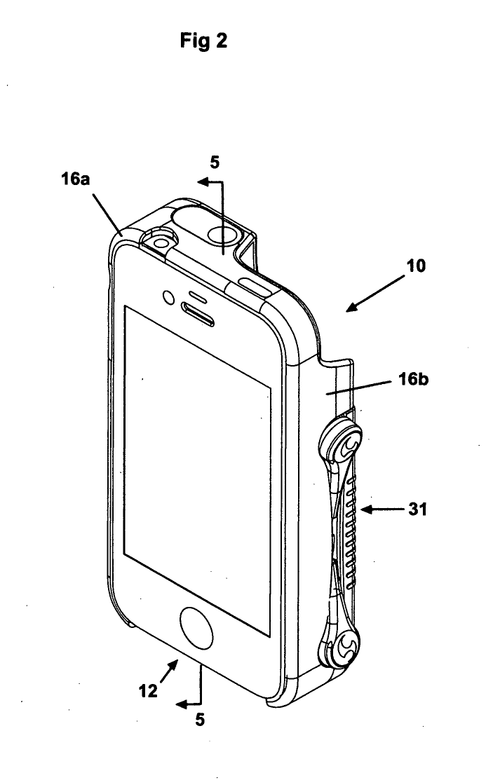

Referring initially to FIGS. 1-4c, there is illustrated a first illustrative embodiment of a case 10 for housing and supporting an electronic device 12 and retractable personal audio speakers 14. The case 10 includes a body 16 which may take the form of any of a variety of shapes and/or sizes depending upon the shape and size of the electronic device 12. For example, the case of the present embodiment is shown with an IPhone® 4 or 4s smart phone and has an overall shape, size and configuration to match that of an IPhone® 4 or 4s, allowing utilization of the various components of the device at their particular locations. Alternatively, the case may be designed in a variety of shapes and sizes, to correspond to the particular electronic device that is to be electronically coupled to the case. Body 16 supports and protects the electronic device 12 and includes an opening 20 that allows a screen 12a of the device to be visible and accessible to a user when the device is supported within the body 16. The body 16 may further include one or more recesses or openings 22 corresponding to the various components and their locations on electronic device 12, such as a power switch, volume control, camera, or other buttons, switches or openings on the device. The body 16 of case 10 may be molded from an impact-resistant plastic or rubber material, a combination of both or a similar material. In the present embodiment the case may be made from plastic, for example an abs polycarbonate blend, with an exterior elastomeric outer coating or skin. The body 16 may be molded from one or more pieces, and includes as first piece 16a and second piece 16b. Alternatively, the body may be molded as a single, unitary member or more than two pieces. The body 16 preferably includes a cavity 18 disposed between first and second pieces 16a, 16b that is sized to support at least a portion of personal audio speakers 14.

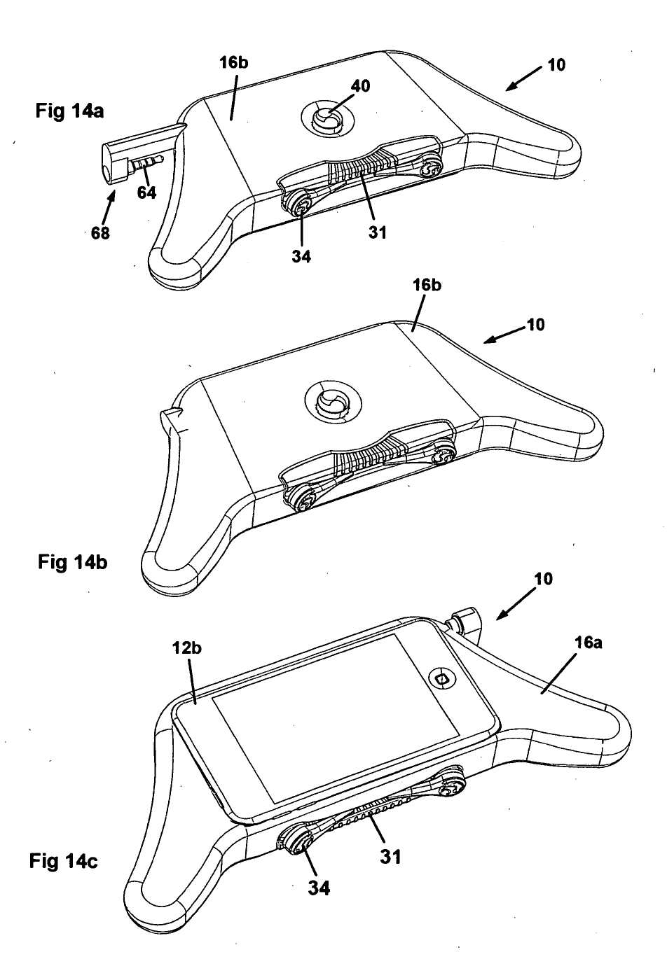

The personal audio speakers 14 include a cord 28 having a first end 28a for connection to a circuit board 27, as described in greater detail below, and a second end 28b which supports an earpiece or ear buds 34 in the present embodiment. Alternatively, the second end 28b may support any device for placement in proximity to the user's ear for listening to the audio transmission from the electronic device. A retraction and extension mechanism 24 is supported by body 16 and includes a spool or reel 38 for selectively winding and incrementally unwinding cord 28. In the present embodiment, the retraction and extension mechanism 24 is disposed within the cavity 18 of the body 16 but alternatively may be supported on an outer surface of the body 16, as shown in FIG. 14.

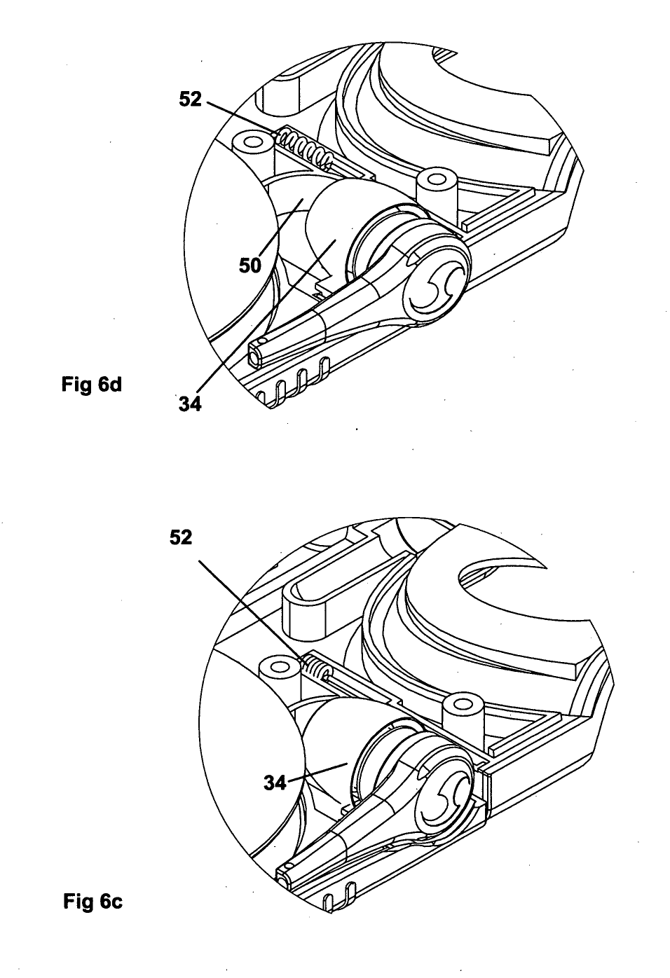

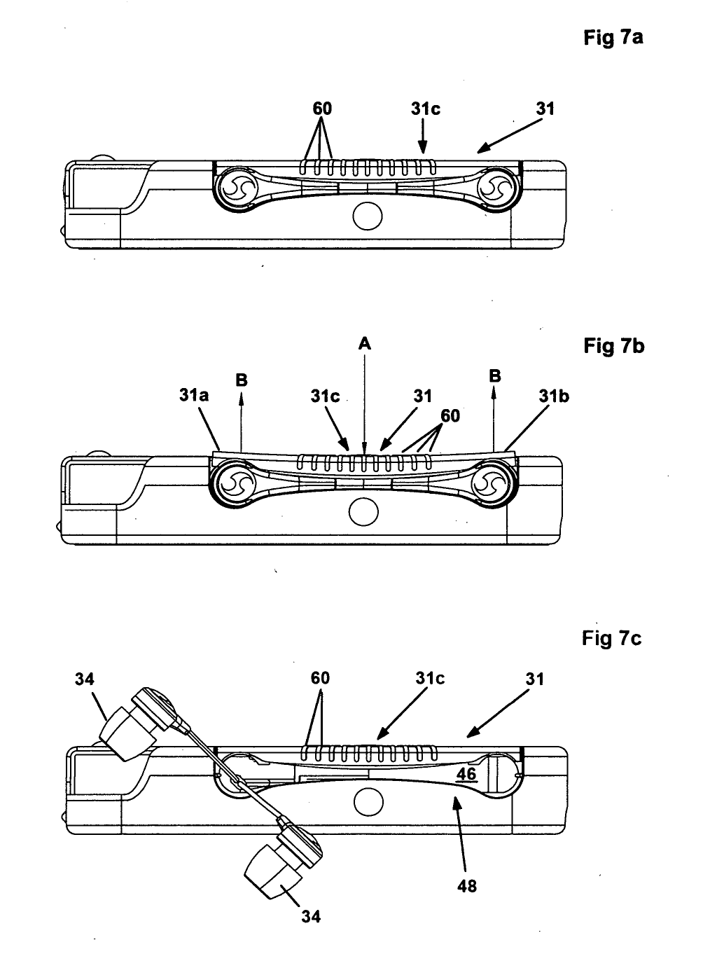

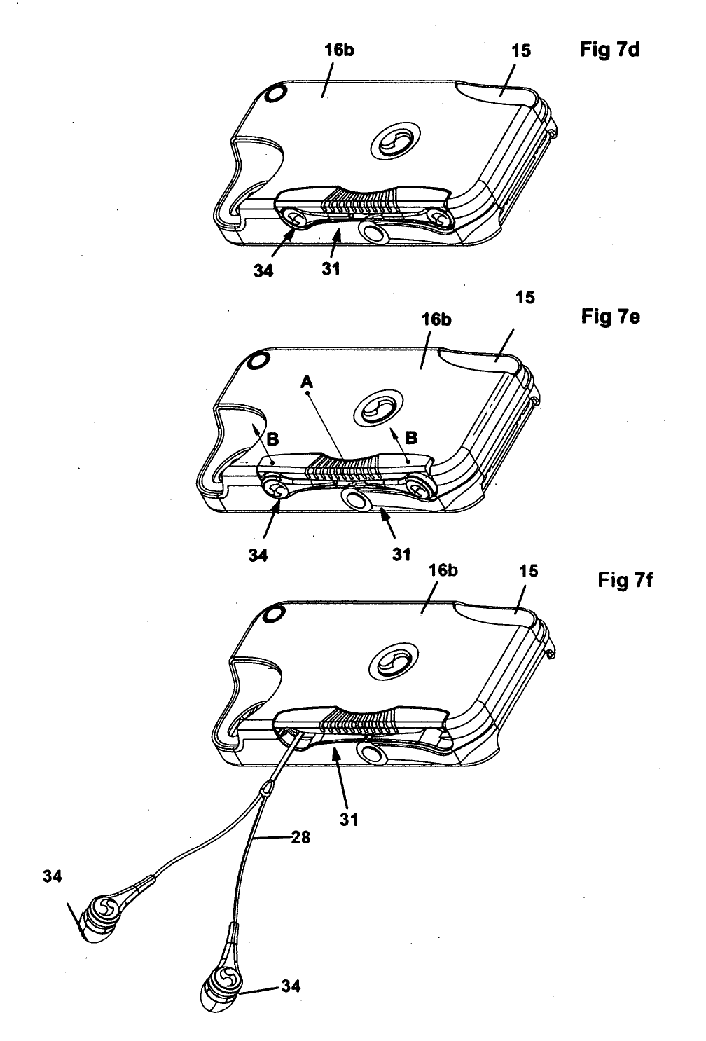

As illustrated in FIGS. 1-4c, reel 38 includes a channel 38a sized to receive a length of cord 28 therein in order to compactly store the cord 28 when not needed and to prevent the cord 28 from becoming entangled. First piece 16a and second piece 16b of body 16 each include corresponding cut-out portions 39a, 39b which form an opening 46 (FIG. 7c) in the case 10 through which the cord 28 can extend when needed. The reel 38 allows a user to selectively unwind a length of cord 28 by pulling the cord 28 from within the case 10 to the desired length. This eliminates excess lengths of cord 28 exterior to the case 10, as the unused length is wound around the reel 38 thus reducing the possibility of the cord 28 becoming tangled or knotted. By allowing the user to selectively unwind a desired length of cord 28 it also makes the use of the personal audio speakers more comfortable, easier and safer for the particular user and activity.

To aid in selectively extending the cord a ratcheting mechanism 36 including a plurality of teeth 36a disposed along the circumference of the center of the reel 38, and mating teeth 36b supported within the housing opposite button 40 are provided in the present embodiment. The teeth 36a supported on the reel 38 engage with the mating teeth 36b supported on the housing and are held in engagement by compression spring 35, which applies pressure to the reel 38 in order to maintain the teeth 36a of the reel in engagement with mating teeth 36b. The ratcheting mechanism 36 operates in a typical manner with the teeth 36a, 36b engaging each other as the reel 38 is rotated in one direction, in order to extend cord 28. The distance between engagements of the teeth 36a, 36b determines the length of cord that is unwound with each ratchet engagement. The engagement of teeth 36a, 36b also prevents the cord 28 from retracting into the case until the user is ready. By providing a ratcheting mechanism 36, the user can selectively choose the desired length of cord for the particular user and activity. When the user desires to return the personal audio speakers 14 within case 10, the cord is again wound around reel 38.

In order to return the selective length of cord 28 that is exterior to case, reel 38 is rotated in a direction opposite that of extraction of the cord 28. This may be done manually, for example by turning a button or knob on the case 10 or by placing a finger in a depression or clasping geometry, in order to rotate the reel 38, which may have a portion extending from case 10. As the user spins the reel 38 manually, cord 28 is retracted into the case and around reel 38. If a ratcheting mechanism 36 is provided, the force of the compression spring 35 needs to be overcome so as to disengage the teeth 36a, 36b in order to wind the reel 38 in the opposite direction and retract the extended length of cord within the channel and around the reel 38. Instead of retracting the cord 28 manually, the cord may be retracted in an “automatic” fashion.

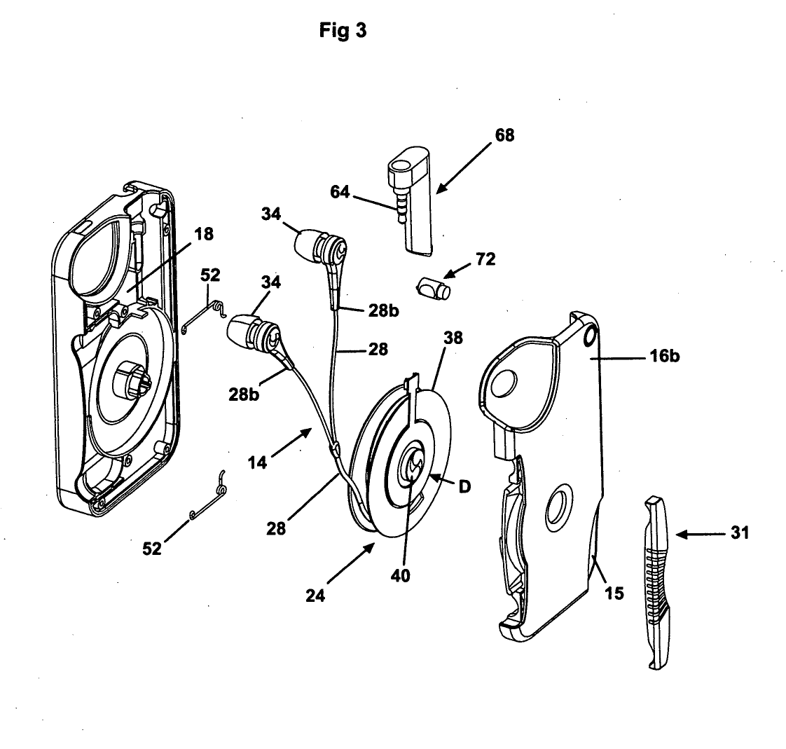

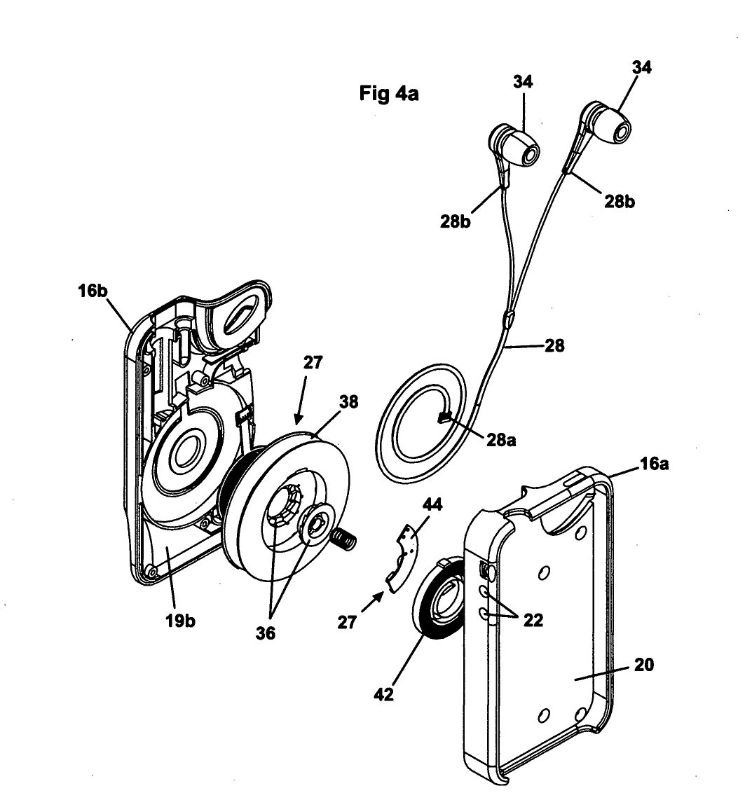

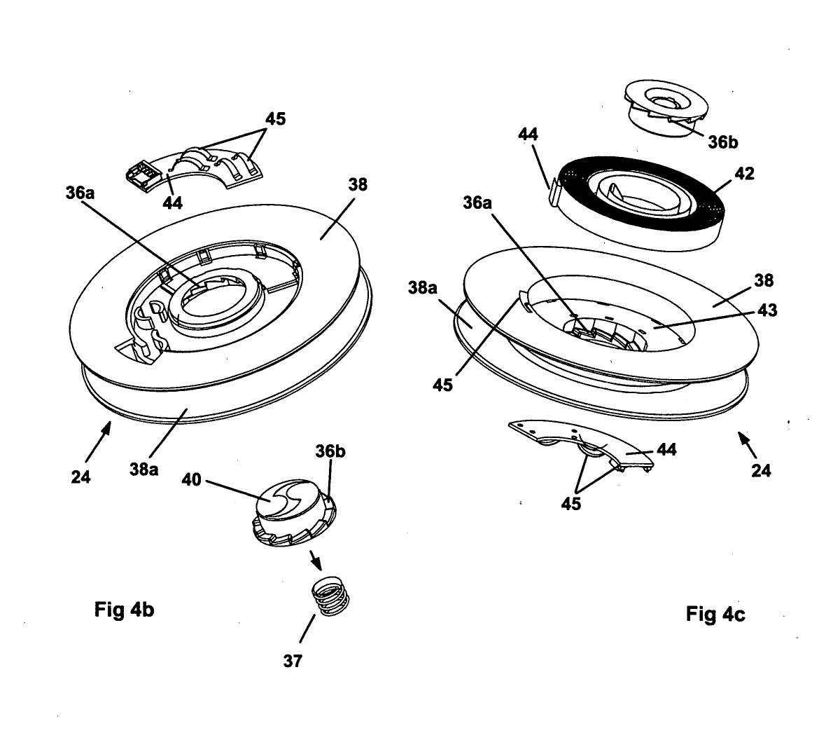

Referring primarily to FIGS. 3-4c, a retraction spring 42 is provided as part of the retraction and extension mechanism 24, to return the length of cord 28 within case 10 in an “automatic” fashion. In the present embodiment, spring 42 is a flat wire supported within shelf 43 of reel 38 and is wound upon its self so as to lay flush, thus reducing wasted space. The flat geometry of the spring also helps prevent twisting or snagging when the wire is rolled and placed within the reel 38. Alternately, a round wire or other spring design may be utilized, as would be known to those of skill in the art. The spring 42 also includes a tab 44, which is fitted within slot 45 of reel 38 in order to hold the spring in place. Spring 42 is supported within reel 38 under tension such that when the teeth 36a, 36b are disengaged, the spring 42 operates to rotate the reel 38 in order to retract the cord 28 into the body 16 in a similar manner as a cord retracting into a vacuum cleaner.

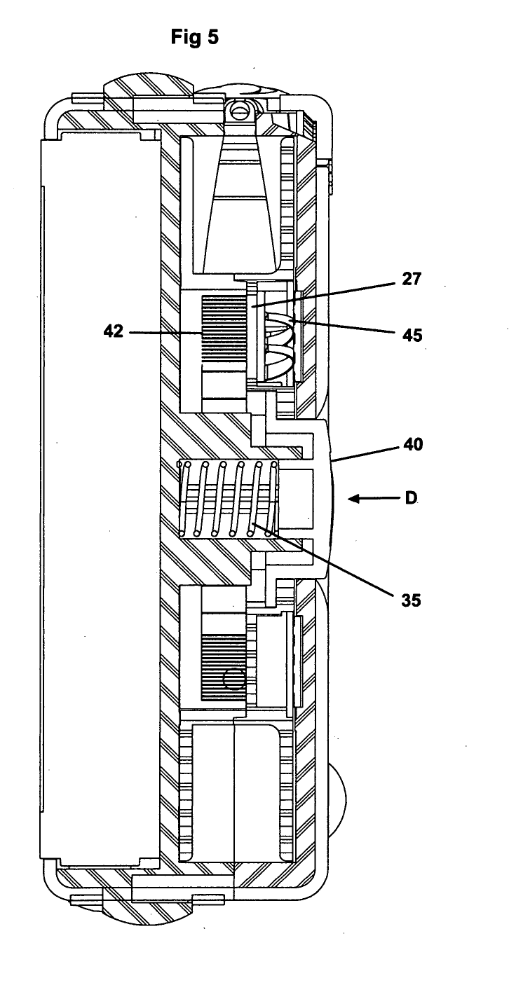

In use, as the personal audio speakers 14 are pulled out of the case 10, reel 38 rotates in a first direction and the cord 28 is incrementally unwound as the teeth 36a, 36b engage each other, as described above. Rotation of reel 38 in the first direction also causes the spring 42 that is attached to reel 38 to wind upon itself, which creates counter force energy. When the flat spring is wound partially or completely it creates energy that spins the reel in a reverse direction when the teeth 36a, 36b are released from engagement with each other, thus drawing the cord 28 back onto the reel 38. A finger target or button 40 is provided which engages with compression spring 35. The button 40 may be part of the case 10, or may be built into a clip or stand member. In the present embodiment when a user depresses button 40, the button moves in a linear manner in the direction of arrow “D” (FIG. 5), and engages compression spring 35 so as to over come the force of spring 35, allowing the teeth 36a, 36b disengage. Once the teeth 36a, 36b disengage, the counter force energy of spring 42 is released, and the spring 42 begins to unwind. As spring 42 unwinds, reel 38 rotates in an opposite direction the first direction, and the cord retracts back into the case in an automatic fashion. This eliminates the need to wrap roll, un-wrap or un-reel the cord when storing and using.

As described above, in addition to cord 28, personal audio speakers 14 also include an earpiece, for example, a pair of ear buds 34 which may have an elastomeric covering that corresponds to the canal of the ear, or similar earpiece devices as would be known to those of skill in the art. The personal audio speakers feature an elastomeric earpiece that corresponds to the canal of the ear, as is known in the art. The elastomeric piece may have any of a variety of designs, for example in one embodiment the earpiece is collapsible and may include bellows (FIG. 19).

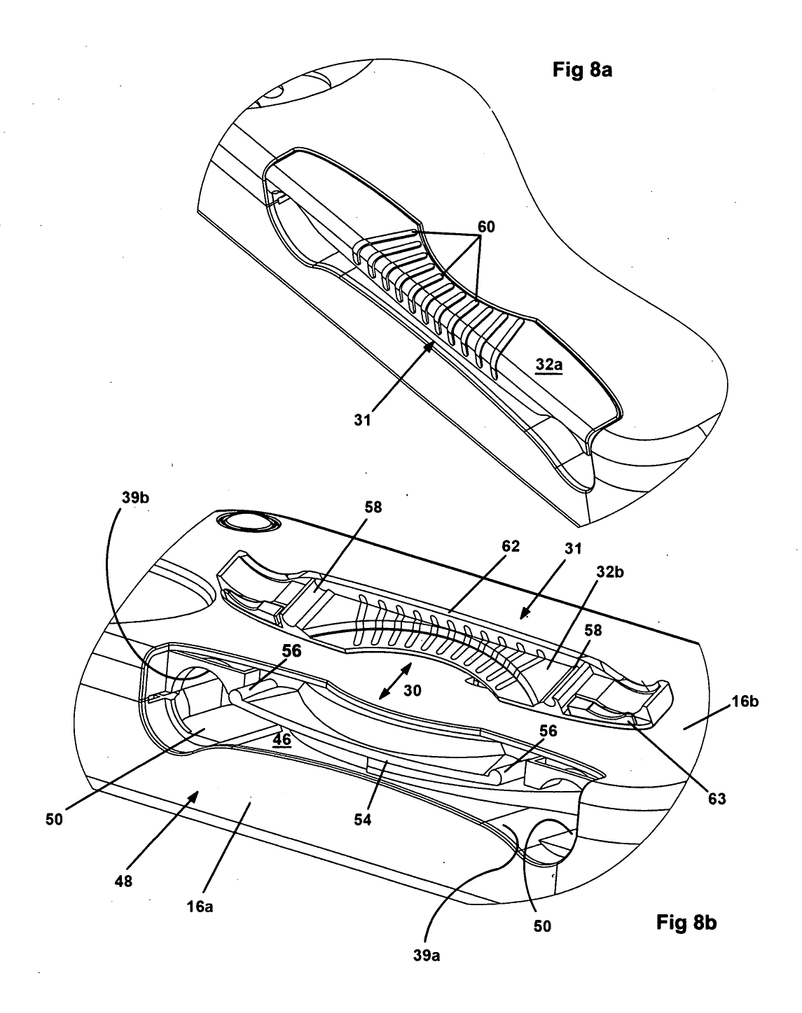

Referring now to FIGS. 7a-8, case 10 may include a storage compartment 48 for securing and storing the earpiece. Storage compartment 48 can be formed as part of case 10 and has a shape and size corresponding to the particular earpiece of the personal audio speakers 14 in order to hold them within the case 10. The compartment 48 may be positioned on any of the faces of case 10, and is disposed on a side face in the present embodiment. As best shown in FIG. 8, storage compartment 48 is accessed by opening 46, defined by cut-out portions 39a, 39b, and includes a geometry 50 for supporting ear buds 34 within case 10. The ear buds may be friction fit within the storage compartment 48, or may be held in mechanically, for example in a snap-fit arrangement by the design of the case, or a combination of the two. In the present embodiment, the geometry 50 of the storage compartment 48 corresponding to the shape and size of ear buds 34 along with release bar 31 to hold the ear buds 34 therein, and biasing springs 52 along with actuation of release bar 31 aids in removal of the ear buds 34 from the case 10. It will be readily understood that the geometry 50 can be varied depending upon the earpiece configuration, for example, if utilizing a collapsible earpiece the geometry 50 may have a reduced depth as the earpiece can be stored in a compressed state when depressed into the storage compartment 48, for example as shown in (FIG. 19).

As best shown in FIG. 8, to release the ear buds 34 from the storage compartment 48 a release mechanism 30 is provided including release bar 31. Release bar 31 is supported over opening 46 and snap-fit to the case 10 by protrusions 56 that mate with corresponding recesses 58 in bar 31. Protrusions 56 are part of lever 54, which is also part of the release mechanism 30. Release bar 31 may be made of an elastomeric, co-molded plastic which includes a harder plastic component co-molded with a more flexible plastic. In this manner, when the rubber is placed in compression, for example when bar 31 is pushed downward as described herein below, it acts in a spring-like manner so that when the compressive force is released, the durometer or memory of the rubber returns the bar 31 back into a non-compressed position. Release bar 31 also include rubber teeth 60 to facilitate gripping of the bar 31, and may also include a limiting boss 63 to hold the bar, and a lip 62 which helps hold the ear buds 34 within the storage compartment 48.

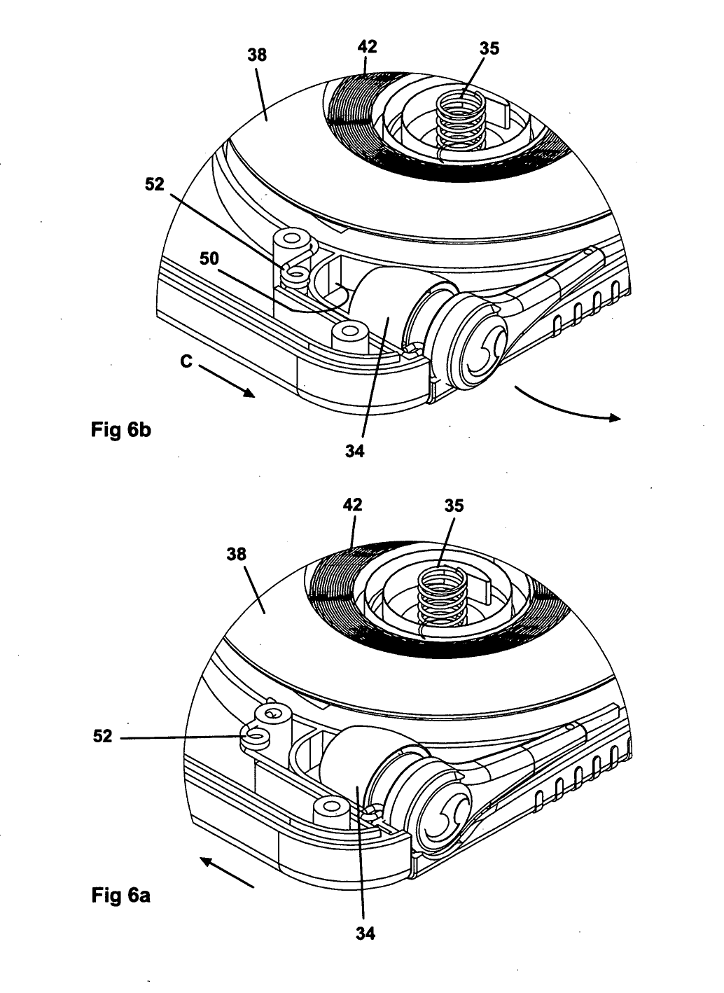

In use, after the cord 28 is refracted within case 10 into the stored position, the ear buds 34 may be supported and secured within storage compartment 48 by the user inserting them therein, through opening 46. As shown in FIGS. 6a and 6b, as the ear buds 34 are inserted within storage compartment 48, they contact the interior geometry 50 of the case and apply pressure to biasing members 52, which put biasing members 52 under tension. The members 52 may be torsion springs as illustrated in FIGS. 6a-6b, may be compression springs as illustrated in FIGS. 6c-6d, or may be any of a variety of biasing members. Once inserted, the ear buds 34 are held in place by the geometry 50 of the storage compartment 48 and the release bar 31. In the stored position, the exterior of the ear buds 34 may be substantially flush with the exterior of case 10, or may protrude slightly there from.

As best shown in FIGS. 7a-7c, to remove the ear buds 34 from within storage compartment 48, release bar 31 is actuated by pushing on the bar 31 near its center 31c where rubber teeth 60 are positioned, in the direction of arrow “A”. As the center of bar 31 is pushed in the direction of arrow “A”, the sides 31a, 31b of the bar move in the direction indicated by the “B” arrows, thus releasing the tension on biasing springs 52 (FIGS. 6b and 6d), which in turn pushes the ear buds 34 in the direction of arrow “C”, at least partially out of the storage compartment 48. Once the ear buds 34 are at least partially out of the storage compartment 48, they can be grasped by the user and pulled in order to release cord 28 from within case 10, as described in greater detail herein above.

Alternately, the ear buds 34 may be removed from the case by other methods or mechanisms, including by manually removal, for example by the user grasping and pulling on the earpiece, or by utilizing alternate securing and release mechanisms. For example, if a collapsible earpiece is utilized, the elastomeric earpiece itself may act as a biasing spring so as to raise it from the face of the case when a locking mechanism holding the earpiece in a compressed state is disengaged. In another example, the ear buds may be secured into the storage compartment by magnetic force. A magnet may be included as part of the interior wall of the storage case. This magnet or magnets create a magnetic field that draws the metal or metalized part on the ear buds into the cavity, helping to them into the correct position as well as securely holding them in place.

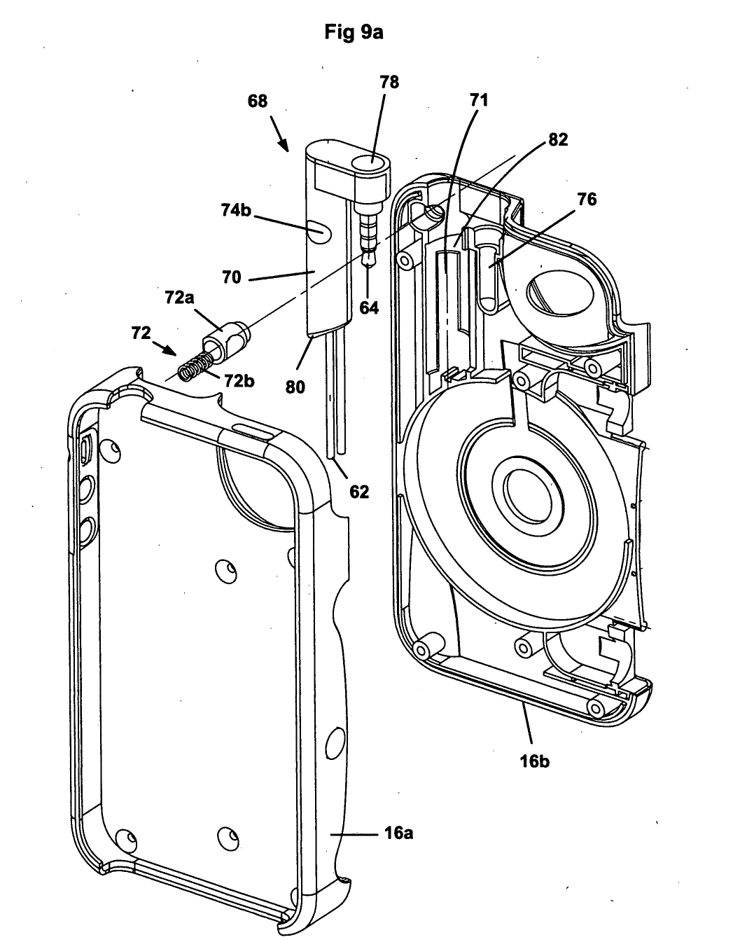

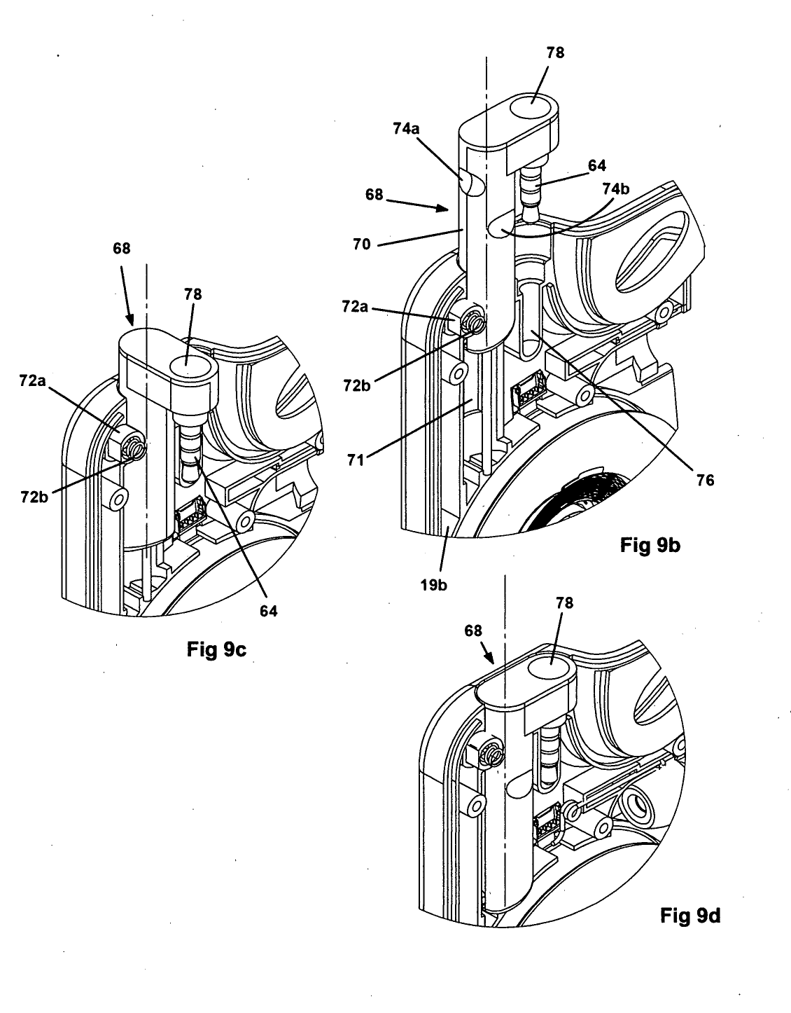

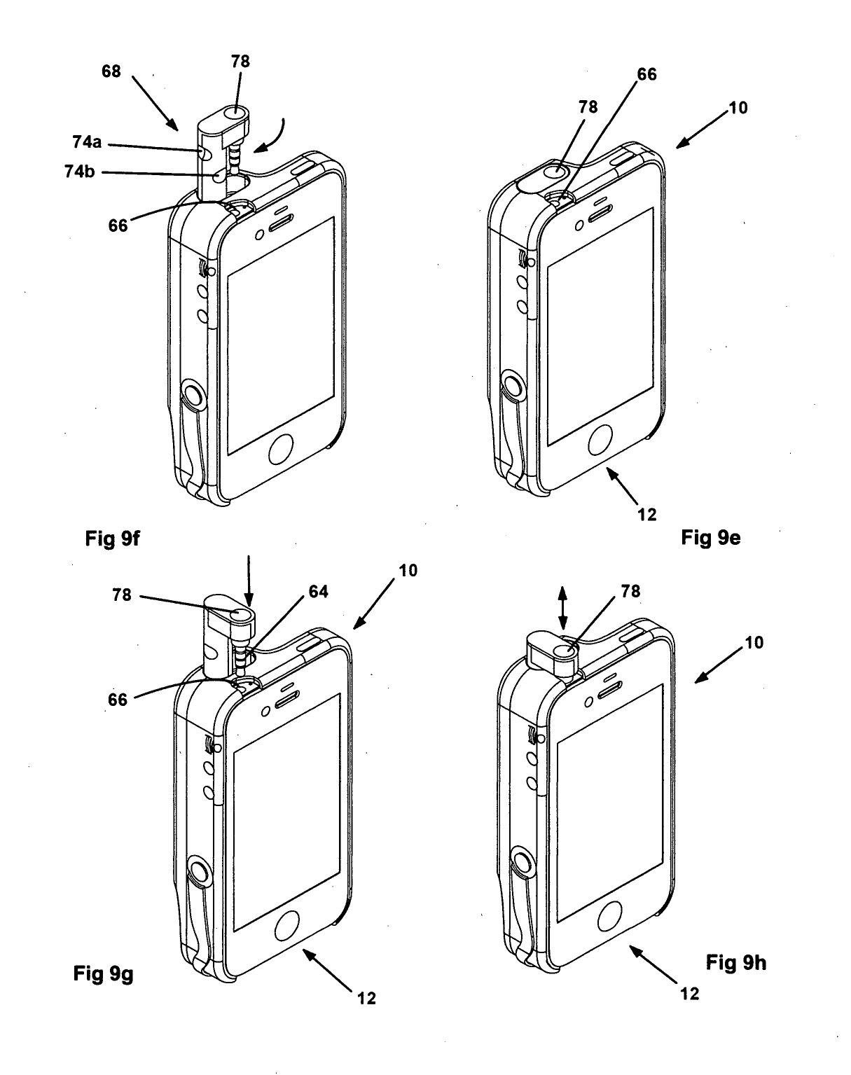

Regardless of the storage mechanism, in order to use ear buds 34, they must first be electronically connected to the electronic device 12. With continued reference to FIGS. 3-5, to establish a connection, the first end 28a of electrical cord 28 is connected, for example by soldering using surface mount technology or by using a mating micro connector or the like, to printed circuit board 27. In the present embodiment, the first end 28a is mounted to plate 44 that supports contact fingers 45, which ride on the printed circuit board 27 during use and maintain continuous electrical contact with the circuit board 27. A wire 62 is also electrically connected to the printed circuit board 27, for example by soldering, and terminates in a tip ring sleeve, or TRS, male conductor plug 64 as best shown in FIG. 9a. The combination of the cord 28 electrically connected to contact fingers 27 and wire 62 that terminates to a TRS male conductor plug, maintains a constant electrical connection with the circuit board 27. In order to make the connection with the electronic device 12, the male conductor plug 64 is inserted into a corresponding female headphone jack 66 in the electronic device. Likewise, to disable the connection with the electronic device 12, the male conductor plug 64 is removed from engagement with female jack 66. In order engage and disengage the plug 64 from jack 66 in an easy and secure member, the plug 64 is movable relative to case 10 between a retracted or stored position where the plug is disposed within the case and out of engagement with jack 66, an extended position for insertion of the electronic device within the case, and an inserted or engaged position where the plug 64 is inserted within and engaged with jack 66.

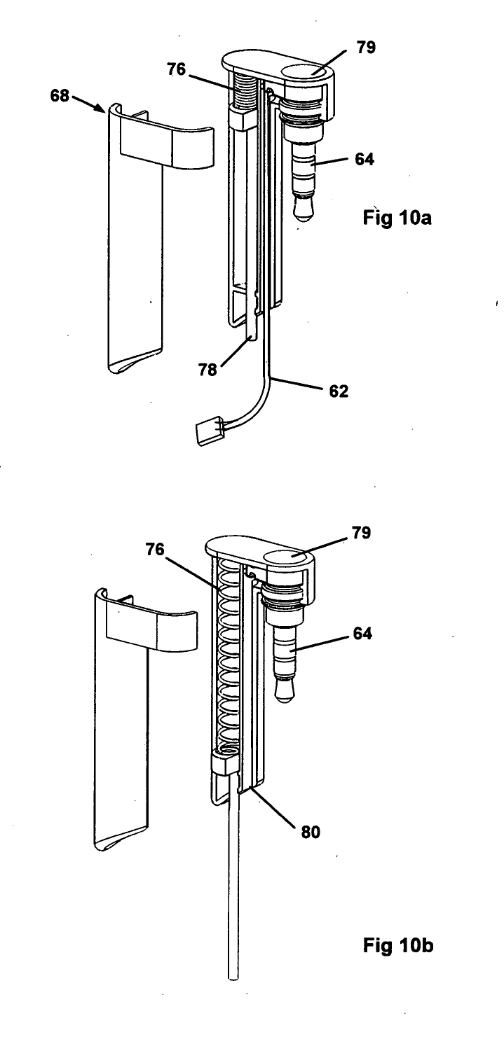

Referring now to FIGS. 9a-10b, an extendable and retractable popper mechanism 68 is provided in the present embodiment to move plug 64 between the retracted, extended and engaged positions. The mechanism includes a stem 70 that rides in corresponding track 71 formed in the interior 19b of body 16b as the stem 70 is extended and retracted, as described in greater detail herein below. A releasable stop mechanism 72, for example movable shoulder member 72a and biasing spring 72b, may be supported within body 16 of case 10 to hold the stem 70 in the retracted position within body 16. In the present embodiment, stem 70 includes arcuate recesses 74a and 74b that are selectively positioned on the stem in order to engage and hold the stem within the body 16 of case 10 in both a stored position (when not connected to the electronic device 14) and an engaged position, when electronically connected to the device 14.

As best shown in FIG. 9b-9d, arcuate recess 74a engages releasable stop member 72a when plug 64 is in the refracted position and is aligned and disposed within plug seat 76 in body 16. In this position, biasing spring 72b maintains contact between shoulder member 72a and arcuate recess 74a such that releasable stop mechanism 72 prevents the popper mechanism 68 from extending from case 10. In order to extend popper mechanism 68 from case 10, a biasing spring 76 is provided in the present embodiment.

Biasing spring 76 may be a compression spring that is operatively connected to a piston rod 78 disposed in stem 70 in order to create a force sufficient to at least partially extend the stem 70 from the body 16 of case 10 when releasable shoulder member 72a is disengaged from either recess 74a, 74b. In the present embodiment, to disengage shoulder member 72a from recess 74a when the popper mechanism 68 is in the retracted position and not connected to an electronic device, the user can push on a finger target 79 disposed on an outer surface of the popper mechanism 68. By applying a sufficient force, the stop member 72a is moved from engagement with the arcuate recess 74a as the spring 72b is compressed by movement of stem 70 and the arcuate geometry of recess 74a.

Once shoulder member 72a is disengaged from recess 72a, biasing spring 76 moves stem 68 in an upward direction, extending from case 10 (FIG. 9b). Alternately, a user can manually extended the stem 70 by grasping and pulling on the stem 70, for example by providing a tab, finger grip, or the like on the stem for the user to grasp in order to overcome the releasable stop mechanism 72.

As the stem 68 extends from the case, the plug 64 may be rotated into alignment with the position in the case 10 for jack 66. The stem 68 may be manually rotated by the user, or may include an angled surface 80 that is guided by a corresponding radius edge 82 in case 10 to rotate the popper and align male plug 64 with female jack 66. When the stem 68 is actuated to its maximum height it clears the face of the case 10 so that electronic device may be readily removed from or inserted into the case 10. Once the stem 70 is actuated to its maximum height and plug 64 is rotated into position in alignment with female jack 66, the popper mechanism 68 can be depressed by the user, again applying a force to finger target 79 in order to move the stem 70 downward, along track 71 and into case 10.

As stem 70 is forced downward, into case 10 in the rotated position (FIG. 9c), recess 74b is now position to be engaged by releasable shoulder member 72a. When plug 64 is inserted within female jack 66, releasable shoulder member 72a is aligned with and engaged within arcuate recess 74b, and stem 70 is fully inserted within case 10 in the engaged position. To remove the plug 64 from within female jack 66, the releasable shoulder member must be disengaged from the arcuate recess 74b. To do this, a user again applies a sufficient force to finger target 79 so that the shoulder member 72a is moved from engagement with the arcuate recess 74b as the spring 72b is compressed by movement of stem 70 and the arcuate geometry of recess 74b. Once shoulder member 72a is disengaged from recess 72b, biasing spring 76 again moves stem 68 in an upward direction, extending from case 10 (FIG. 9g).

Stem 70 may be formed of a single, unitary piece, or may be made of two or more parts. If the stem includes two or more parts, then those parts may be actuated parts connected by a linkage that allows the linked parts to pivot with a fulcrum. In this manner, the stem has increased flexibility when actuated to remove and insert the male plug into or out of the female jack as shown. As will be appreciated, by providing an extendable and retractable popper mechanism 68 as described herein above, the user can readily insert the male plug 64 into the female jack 66 even with a one handed operation, with or without looking at the device. This attachment also provides an electrical connection and semi-permanent union between the electronic device and the personal audio speakers.

In addition to the foregoing, case 10 may further include addition features, as desired. For example, the case 10 may also include ergonomic features, such as a finger support 15 (FIG. 1) that interacts ergonomically with the finger of a user to aid in holding the case and manipulating the personal audio speakers 14. Support 15 may have a concave surface positioned on the body 16 of the case 10, for example on a corner, the majority of the concave surface sitting slightly below the surface of the case. The finger support 15 allows the user to readily hold the case as they manipulate other features of the case 10. For example, as the user presses button 40 when storing the personal audio speakers they can easily hold the case as they are doing so. The concave design or other geometry reduces the chance that the finger will slip off the back of the case when depressing the ear buds when storing. The concave design or other geometry also aids in placing and positioning the personal audio speakers into the ear canal as the case is being held. The finger support 15 may have a non-slip surface, or other tactile element to also aid ergonomically.

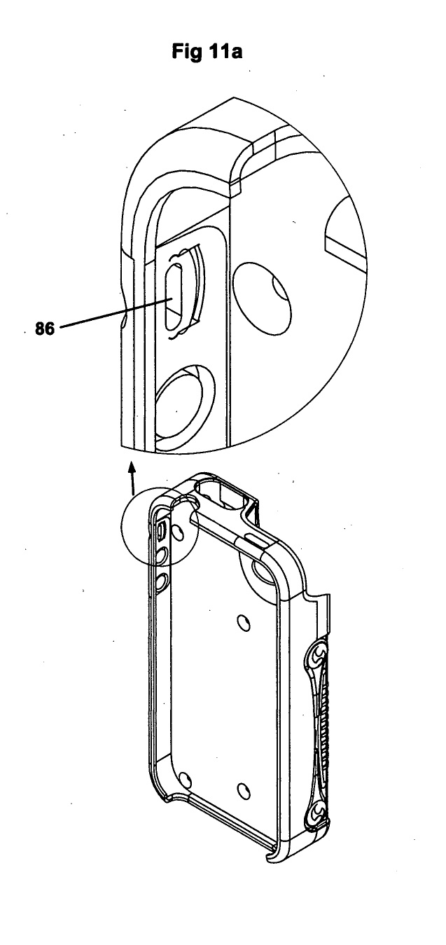

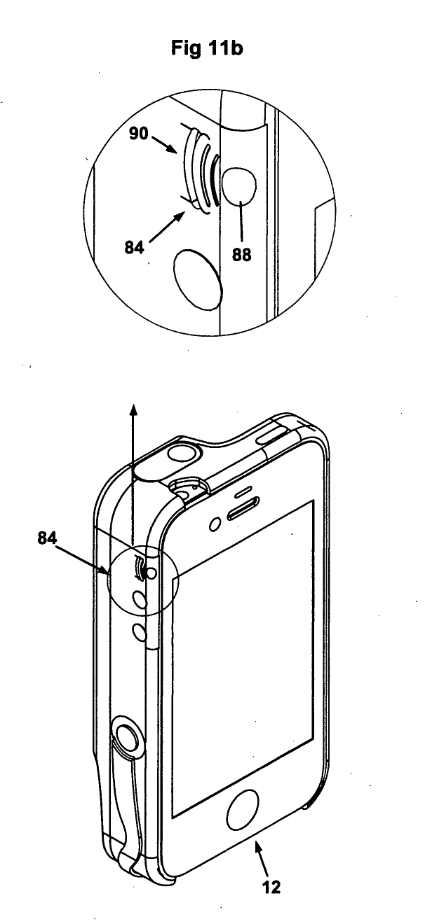

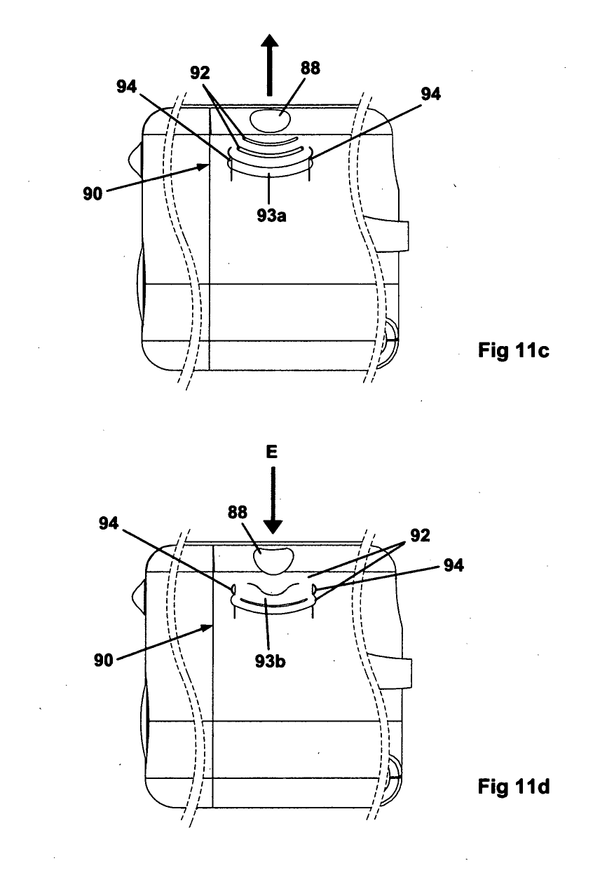

Referring now to FIGS. 11a-11d, an elastomeric mute button assembly 84 may be provided. Mute button assembly 84 may include an opening 86, a cover 88 and a mute indicator 90. Opening 86 and cover 88 have a shape and size corresponding to and aligned with a mute button of the electronic device 12. Opening 86 receives the mute button therein and cover 88 provides protection over the mute button of the electronic device from dust, dirt and other debris. The mute button assembly 84 is preferably made of an elastomeric material that is compressible and which can be engaged by a user to push the mute button between its on and off position.

Mute indicator 90 provides a visual indication of when the mute button is engaged and includes two or more deformable, reduced-thickness portions 92 that aid in depression of the button by deforming when compressed. In use, as the cover 88 of mute button assembly 84 is compressed in the direction of arrow “E”, the cover 88 is deformed, as are reduced thickness portions 92. By providing for the reduced thickness portions 92, the mute button assembly 84 has a bellows-like design, including expansion portions 93 that expand slightly as reduced thickness portions 92 are deformed during compression. Mute button assembly 84 may also include one or more tabs 94 that engage and hold expansion portions 93 in both the initial, non-muted position (FIG. 11c) and the deformed or muted position FIG. 11d. In the non-muted position illustrated in FIG. 11c, the tabs 94 engage a lower expansion portion 93a and when in the muted position, compressive force applied to the cover 88 causes reduced thickness portions 92 to deform and disengage the lower expansion portion 93a from tabs 94 which are moved into engagement with upper expansion portion 93b. Because the tabs 94 hold the upper expansion portion 93b in the muted position and the upper expansion portion 93a in the un-muted position, there is a difference in the visual appearance between the muted and non-muted appearance which enables a user to visual identify when the device 12 is muted even though the mute button of the electronic device may not be visible through cover 88.

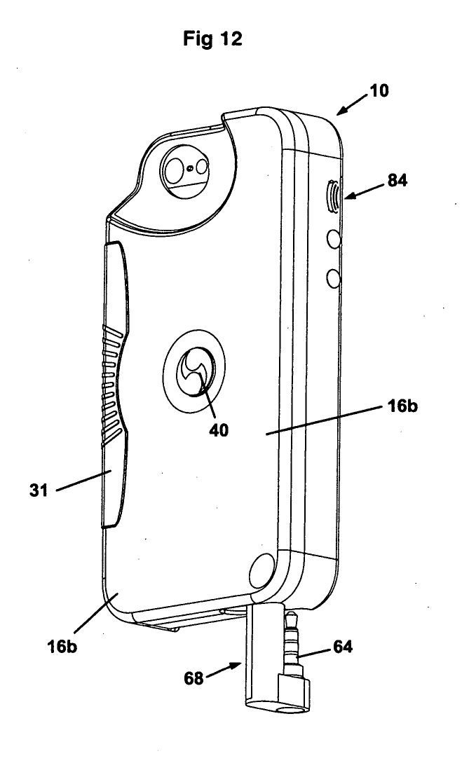

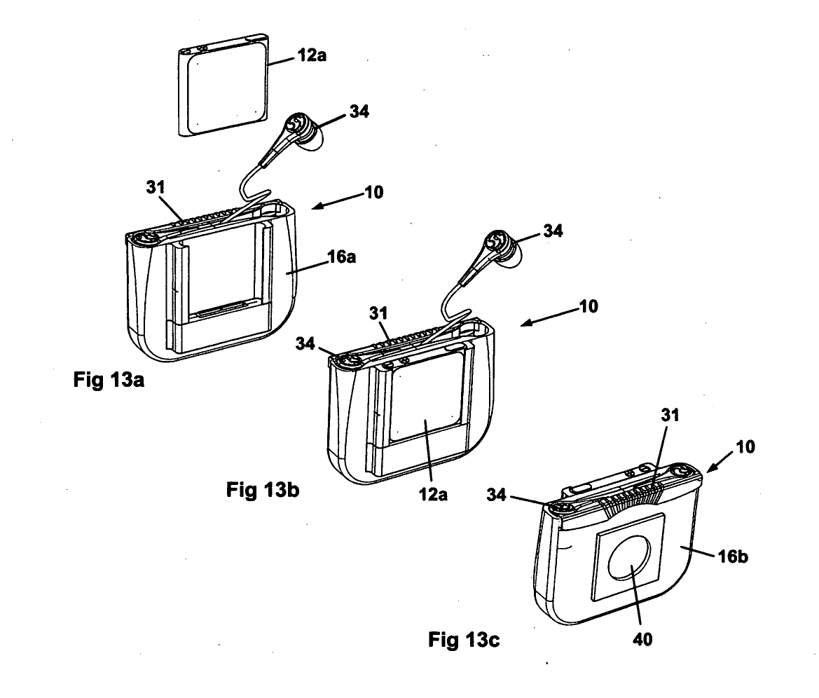

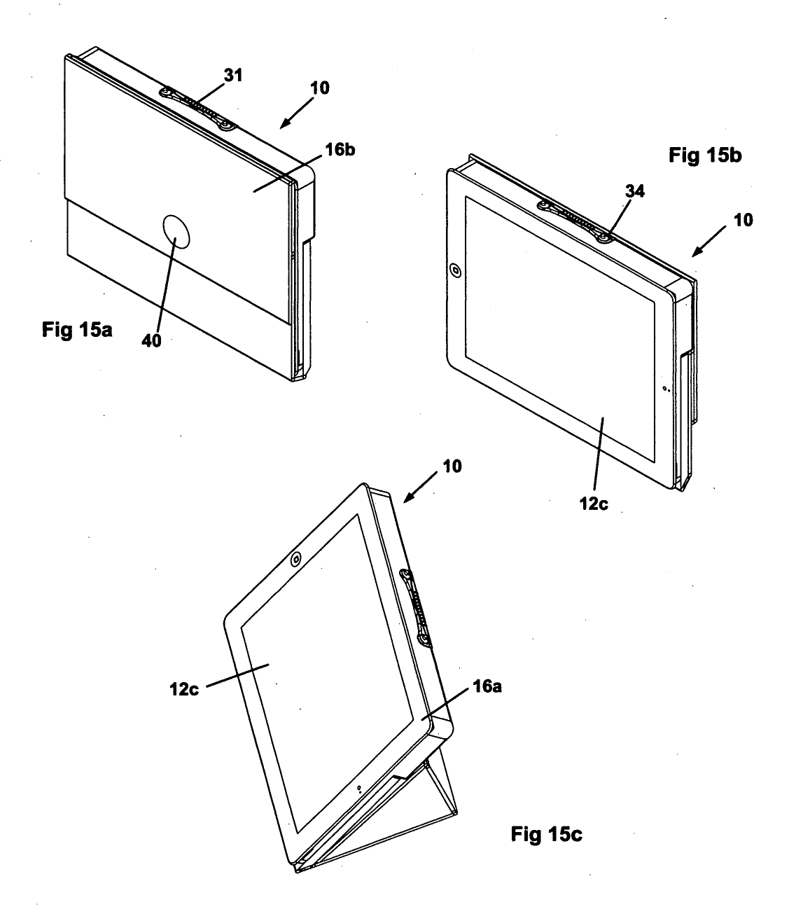

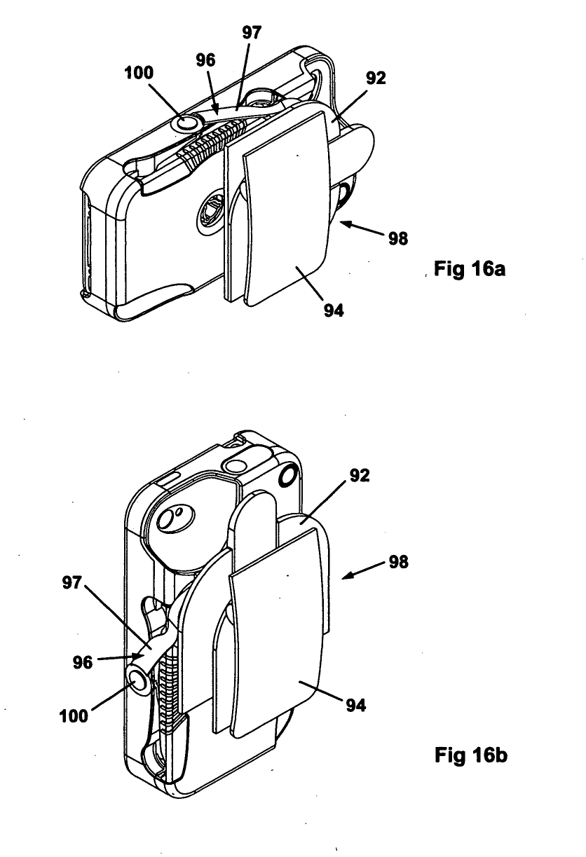

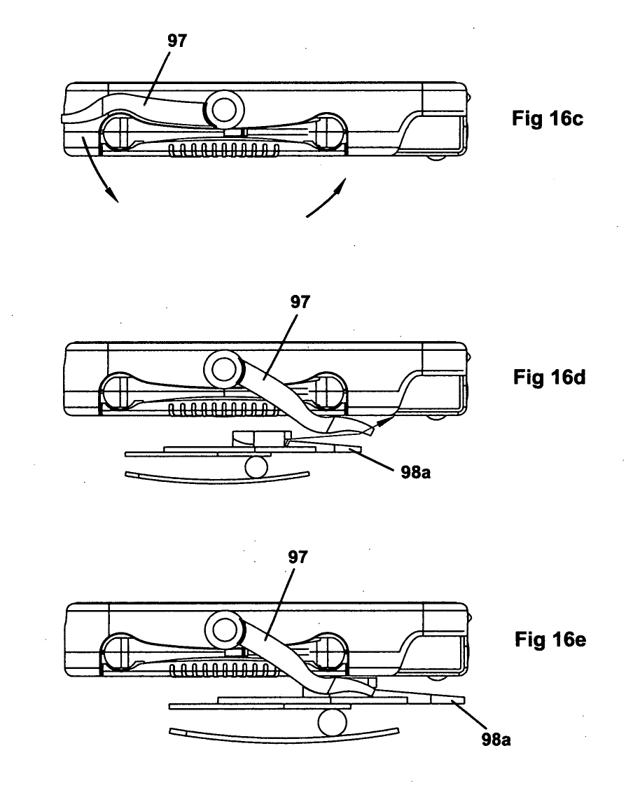

Referring now to FIGS. 12 and FIGS. 15-15c there is illustrated the case 10 for use with a variety of different electronic device 12, the case having a shape and size corresponding to the particular electronic device, but otherwise having the features described herein above. In FIG. 12, an IPhone 5® is illustrated, in FIGS. 14a-15c an audio device, for example an IPhone® Nano® 12a as illustrated, in FIGS. 16a-16c a gaming device 12b is illustrated, and in FIGS. 15a-15c a computing device, such as an IPad® 12c is illustrated.

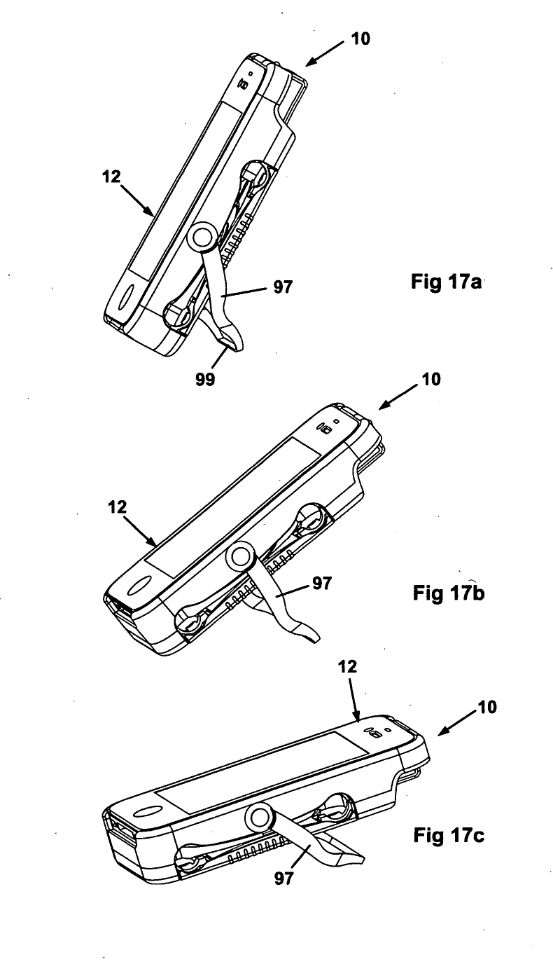

Referring now to FIGS. 16a-17c there is illustrated a stand 96 and clip 98 that may be provided in conjunction with case 10. As best shown in FIGS. 16a-16c, stand 96 may include legs 97 and support 99 that are rotatably connected to the sides of case 10 at pivot point 100. By rotatably connecting the stand 96, it can be moved between a stored position where it is substantially flush with the case 10 (FIG. 16c), into a number of different angles to support the electronic device 12, for example in a profile, i.e. vertical position (FIGS. 17f-17h). The angular adjustment of the stand makes it possible to view the device screen or other interfaces at an optimum viewing angle. The stand may or may not have elastomeric feet that serve as a gripping device as well as a friction lock to hold the stand securely against the case.

To help support the electronic device 12 and case 10 in a landscape, or horizontal position rotatable clip 98 may be provided. As is conventional, clip 98 may also be used to secure the case 10 to a belt or other item. As such, the clip includes clipping members 98a, 98b that attach to a surface by creating tension between the two members, as is known in the art. In the present embodiment, as shown in FIGS. 16a and 16b, the clip 98 can also rotate from a first position (FIG. 16b) where the clip 98 can secure the case 10 in the profile position to an item into a second position (FIG. 16a) where the clip 98 can secure the case 10 in the landscape position to an item, or where the clip can 98 be used as part of the stand 96 to support the case 10 on a surface in the landscape position. As shown in FIGS. 16c-16e, the clip 98 can rotate outward from the case 10 by being attached by a back plate 98a to the stand 96. Alternatively, clip 98 can be supported on case 10 without stand 96 and operate in a conventional manner to attach the case 10 to a belt or other item, with or without rotation.

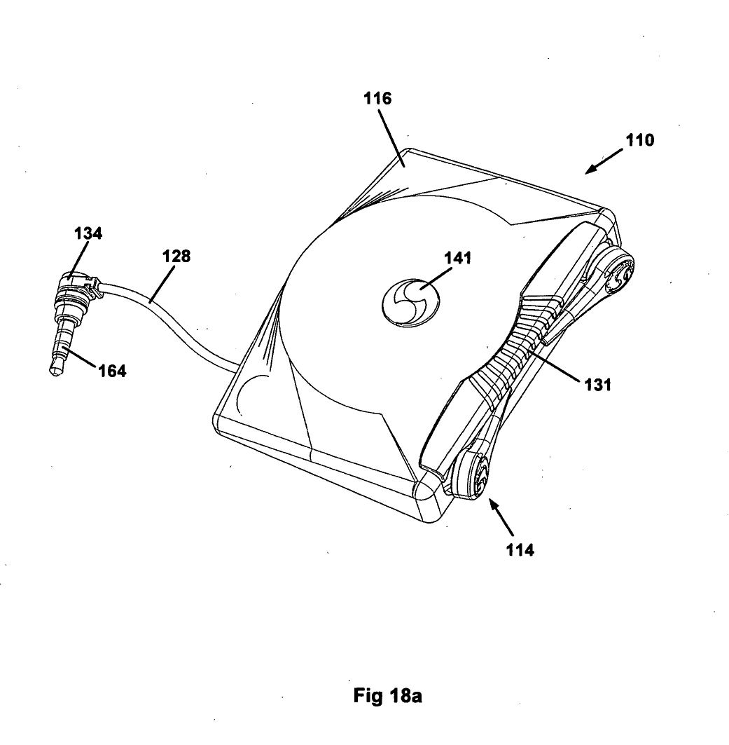

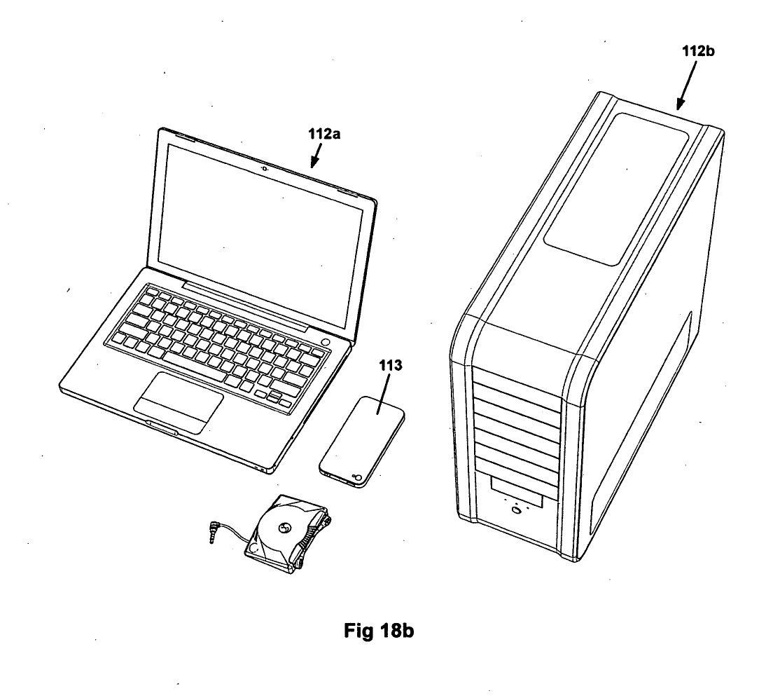

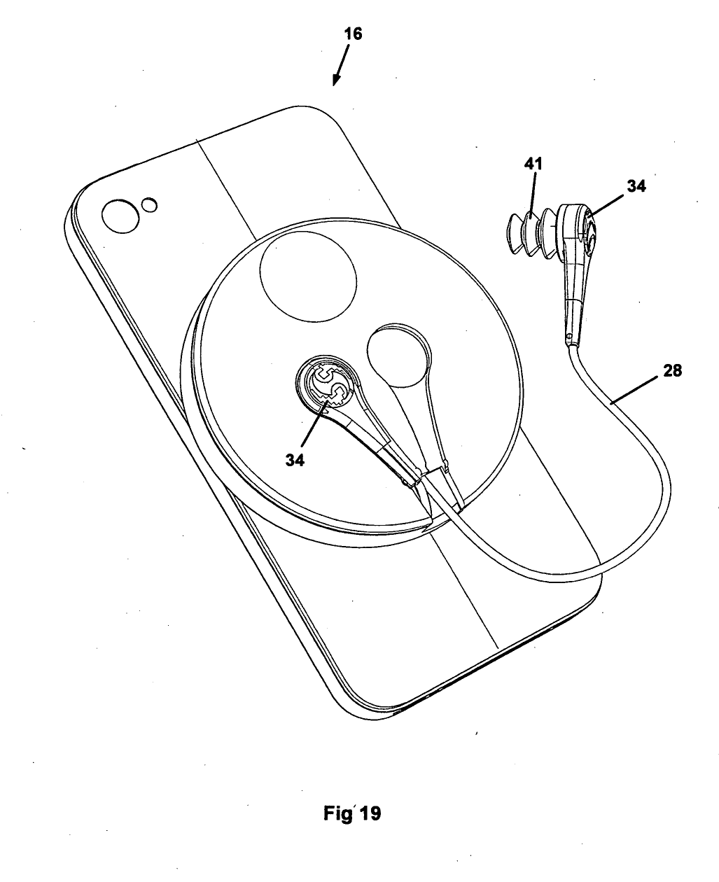

Referring now to FIGS. 18a-18b, an alternate embodiment of case 10 is illustrated. In this embodiments, the same or similar elements as the previous embodiment is labeled with the same reference numbers, preceded with the numeral “1”. In the embodiments of FIGS. 18a-18b, the case 110 is stand-alone, i.e. the electronic device is not disposed within the case body 116. Case 110 may be electronically connected by plug 164 to any of a variety of electronic devices, for example laptop 112a or cpu 112b. Body 116 of the case 110 includes a different exterior design than the previous embodiment, since it is not limited to the shape and or size of the electronic device. The geometry of body 116 may be widely varied, and is rectangular in the present embodiment with a substantially flat face 113 that can rest on a flat surface, but does still include a cavity to support the extension and retraction mechanism as in the previous embodiment. In addition, because the electronic devices 112a, 112b are not disposed within the case body 116, the extendable and retractable popper mechanism may also be eliminated. Instead, the plug 164 can be extended and retracted from case 110 in a conventional manner, or can include a retraction and extension mechanism similar to that of personal audio speakers 114, as described herein above with respect to the first embodiment.

In all of the foregoing embodiments, a case is provided that supports the integrated personal audio speakers, the personal audio speakers being easily accessed for use and storage by the majority of users. The case may also include an extension and retraction mechanism to allow for incremental adjustment of the personal audio speakers and retraction of the same into the case and may be configured to store and protect the electronic device as well.

Having thus described several illustrative embodiments, it is to be appreciated that various alteration, modifications, and improvements will readily occur to those skilled in the art. Such alterations, modifications, and improvements are intended to form a part of this disclosure, and are intended to be within the spirit and scope of the invention as defined by the appended claims. For example, the earpiece retraction mechanism may be manual or automatic and in either case may have a different shape, size, geometry and components than disclosed herein. Likewise, the extension and retraction mechanism for the stem may be manual or automatic and in either case may have a different shape, size, geometry and components than disclosed herein. Also, it is to be understood that any directional indications are not intended as limiting and may be readily reversed. For example, rotations may be clockwise or counter-clockwise and pushing may be reversed to pulling and vice versa.

In addition, while some examples presented herein involve specific combinations of functions or structural elements, it should be understood that those functions and elements may be combined in other ways according to the present disclosure to accomplish the same or different objectives and some functions or elements may be eliminated, as desired. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

What is claimed is:

1. A case for audio connection with an electronic device comprising:
a body including an exterior and an interior, the interior including a cavity;
a personal audio device including a cord having a first end supported by the case, and a second end supporting an earpiece;
an audio plug supported by the body of the case and movable between an extended position wherein the plug extends exterior to the body, and a retracted position wherein the plug is supported interior to the body, the audio plug being operatively connected to the personal audio device;
a retraction and extension mechanism supported by the body including:
a) a reel constructed and arranged to support a portion of the cord thereon, the cord being at least partially wound about a portion of the reel, the reel being rotatable in at first direction and a second direction, opposite the first direction; and
b) a ratcheting mechanism constructed and arranged to incrementally move the reel in the first direction when in an engaged position and to prevent movement in the second direction when in the engaged position; and
wherein during use the audio plug is extended from the body and inserted within a corresponding audio jack in the electronic device to connect the personal audio device to the electronic device and wherein the personal audio device is selectively and incrementally extended from the body by a user pulling the cord from the case causing the ratcheting mechanism to rotate the reel incrementally in the first direction.

2. The case of claim 1, further comprising a track formed in the interior of the body and an extendable and retractable popper mechanism constructed and arranged to support the audio plug, the popper mechanism including a stem constructed and arranged to ride in the track to move the plug between the extended and the retracted position, and wherein in the retracted position the plug may further be positioned in a stored position within the case body.

3. The case of claim 2, wherein the popper mechanism includes a releasable stop member constructed and arranged to engage and hold the stem within the body in the stored position disposed within a plug seat in the body and in an engaged position wherein the plug is inserted within the audio jack of the electronic device.

4. The case of claim 3, wherein the releasable stop member includes a movable shoulder member and a biasing spring supported by the housing, the movable shoulder member constructed and arranged to engage one or more recesses positioned on the stem in the stored position and the engaged position.

5. The case of claim 4, wherein the one or more recesses includes at least a first recess positioned on the stem in alignment with the releasable stop member when the stem is in the stored position such that the biasing spring maintains contact between shoulder member and the at least first recess to hold the audio plug within the case, and at least a second recess positioned on the stem in alignment with the releasable stop member when the stem is in the engaged position such that the biasing spring maintains contact between the shoulder member and at least the second recess to hold the audio plug within the audio jack.

6. The case of claim 4 wherein the popper mechanism includes a biasing spring operatively connected to the stem, wherein upon applying a sufficient force to the releasable stop member to remove the stop member from engagement with the one or more recesses, the audio plug is biased out of the body of the case by the popper mechanism biasing spring.

7. The case of claim 1, wherein the retraction and extension mechanism further includes a plurality of teeth supported by the reel and mating teeth supported by the housing, the teeth and mating teeth being held into engagement by a biasing member, and a retraction spring supported by the reel and constructed and arranged to return the cord within the body of the case upon release of the teeth from engagement with the mating teeth.

8. The case of claim 7, further comprising a button supported by the body and constructed and arranged to move in a first direction into the body to engage the biasing member in order to release the teeth from engagement with the mating teeth, and in a second direction to a rest position out of engagement with the biasing member.

9. The case of claim 8, further comprising a retraction spring supported by the reel and woundable upon itself, and wherein the retraction spring is supported within the reel under tension such that when the teeth are released from engagement with the mating teeth, the retraction spring operates to rotate the reel in order to retract the cord into the body.

10. The case of claim 1, wherein the electronic device is removably supported within the body.

11. The case of claim 1, wherein the retraction and extension mechanism is disposed within the cavity of the body.

12. The case of claim 1, further comprising a storage compartment having a geometry constructed and arranged to support the earpiece therein and at least one biasing member, and wherein upon insertion of the earpiece within the storage compartment the at least one biasing member is put under tension.

13. The case of claim 12, further comprising a release mechanism including a release bar constructed and arranged to release the tension on the biasing member of the storage compartment when actuated, in order to urge the earpiece at least partially out of the storage compartment.

14. The case of claim 1, wherein the first end of the cord is operatively connected to one or more contact fingers, the contact fingers riding on a printed circuit board during use in order to maintain continuous electrical contact with the circuit board during use.

15. The case of claim 14, further comprising a wire electrically connected to the printed circuit board and terminating in the audio plug such that a constant electrical connection is maintained with the circuit board.

16. The case of claim 1, further comprising a mute button assembly including an opening configured and sized to receive a mute button of the electronic device therein, a cover constructed and arranged to provide protection from debris, and a mute indicator to provide a visual indication of when the mute button is engaged.

17. The case of claim 16, wherein the mute indicator includes two or more deformable portions that deform when the cover of the mute button assembly is compressed and wherein deformation provides a visual indicator that the mute button is muted and when not deformed a visual indication that the button is un-muted.

18. A case for audio connection with an electronic device comprising:
a body including an exterior and an interior, the interior including a cavity;
a personal audio device including a cord having a first end supported by the case and a second end supporting an earpiece;
an audio plug operatively connected to the personal audio device and supported by the body of the case and further being constructed and arranged to electrically connect to an audio jack of the electronic device;
a popper mechanism constructed and arranged to move the audio plug between an extended position wherein the plug extends exterior to the body, and a retracted position wherein the plug is supported at least partially within the body, and further including a releasable stop member constructed and arranged to hold the audio plug within the body in the retracted position;
a retraction and extension mechanism supported by the body and constructed and arranged to releasably support the cord; and
wherein during use the audio plug is extended from the body and inserted within a corresponding audio jack in the electronic device to electronically connect the personal audio device to the electronic device.

19. The case of claim 18, wherein the popper mechanism includes a stem constructed and arranged to move the plug along a longitudinal axis between the extended position and the retracted position.

20. The case of claim 19, wherein the releasable stop member includes a movable shoulder member and a biasing spring supported by the body, the movable shoulder member being constructed and arranged to engage one or more recesses positioned on the stem in both a stored position wherein the audio plug is retracted and supported within the body, and an engaged position wherein the audio plug is retracted and inserted within the audio jack of the electronic device.

21. The case of claim 20, wherein the popper mechanism includes a biasing spring operatively connected to the stem, wherein upon applying a sufficient force to the releasable stop member to remove the stop member from engagement with the one or more recesses, the audio plug is biased out of the body of the case by the popper mechanism biasing spring.

22. The case of claim 18, wherein the retraction and extension mechanism includes:
a) a reel constructed and arranged to support a portion of the cord thereon, the cord being at least partially wound about a portion of the reel; and
b) a ratcheting mechanism constructed and arranged to incrementally move the reel in a first direction when engaged and to prevent movement in a second direction, opposite the first direction, when engaged.

23. The case of claim 18, further comprising a storage compartment having a geometry constructed and arranged to support the earpiece therein and at least one biasing member, and wherein upon insertion of the earpiece within the storage compartment the at least one biasing member is put under tension.

24. The case of claim 23, further comprising a release mechanism including a release bar constructed and arranged to release the tension on the biasing member of the storage compartment when actuated, in order to urge the earpiece at least partially out of the storage compartment.

25. The case of claim 18, further comprising a mute button assembly including a mute indicator having two or more deformable portions that deform when a cover of the mute button assembly is compressed and wherein deformation provides a visual indicator that the mute button is muted and when not deformed a visual indication that the button is un-muted.

26. A case for audio connection with an electronic device comprising:
a body including an exterior and an interior, the interior including a cavity;
a personal audio device including a cord having a first end supported by the case and a second end supporting an earpiece;
an audio plug supported by the body of the case and movable between an extended position wherein the plug extends exterior to the body, and a retracted position wherein the plug is supported at least partially within the body, the audio plug being operatively connected to the personal audio device;
a retraction and extension mechanism supported by the body and constructed and arranged to incrementally move the cord in a first direction when in an engaged position and to prevent movement of the cord in a second direction when in the engaged position; and
wherein during use the audio plug is extended from the body and inserted within a corresponding audio jack in the electronic device to connect the personal audio device to the electronic device and wherein the personal audio device is selectively and incrementally extended from the body by a user pulling the cord from within the body of in the first direction.
